(19) United States
(12) Patent Application Publication
(10) Pub. No.: US 2023/0313341 A1
(43) Pub. Date: Oct. 5, 2023

(54) COPPER ALLOY PLASTIC WORKING MATERIAL, COPPER ALLOY ROD MATERIAL, COMPONENT FOR ELECTRONIC/ELECTRICAL DEVICES, AND TERMINAL

(71) Applicant: MITSUBISHI MATERIALS CORPORATION, Tokyo (JP)

(72) Inventors: Hirotaka MATSUNAGA, Aizuwakamatsu-shi (JP); Yuki ITO, Ageo-shi (JP); Kosei FUKUOKA, Hokota-shi (JP); Kazunari MAKI, Saitama-shi (JP); Kenji MORIKAWA, Aizuwakamatsu-shi (JP); Shinichi FUNAKI, Aizuwakamatsu-shi (JP); Hiroyuki MORI, Tsukuba-shi (JP)

(73) Assignee: MITSUBISHI MATERIALS CORPORATION, Tokyo (JP)

(21) Appl. No.: 18/003,416

(22) PCT Filed: Jun. 30, 2021
(86) PCT No.: PCT/JP2021/024797

§ 371 Date: Dec. 27, 2022

(30) Foreign Application Priority Data
Jun. 30, 2020 (JP) 2020-112695
Jun. 30, 2020 (JP) 2020-112927
May 31, 2021 (JP) 2021-091161

(51) Int. Cl. C22C 9/00; H01B 1/02

(52) U.S. Cl. CPC C22C 9/00; H01B 5/02; H01B 1/026

(57) ABSTRACT

A copper alloy plastically-worked material comprises Mg in the amount of 10-100 mass ppm and a balance of Cu and inevitable impurities, which comprise 10 mass ppm or less of S, 10 mass ppm or less of P, 5 mass ppm or less of Se, 5 mass ppm or less of Te, 5 mass ppm or less of Sb, 5 mass ppm or less of Bi and 5 mass ppm or less of As. The total amount of S, P, Se, Te, Sb, Bi, and As is 30 mass ppm or less. The mass ratio of [Mg]/[S+P+Se+Te+Sb+Bi+As] is 0.6 or greater and 50 or less. The electrical conductivity is 97% IACS or greater. The tensile strength is 275 MPa or less. The heat-resistant temperature after draw working is 150° C. or higher.

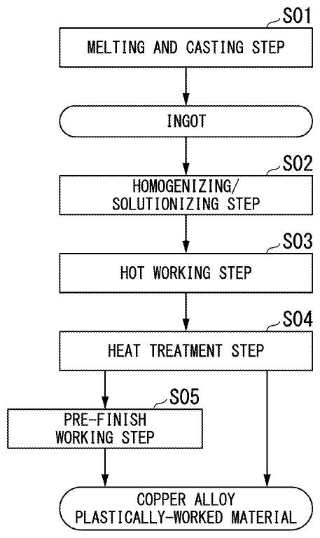

### CROSS-REFERENCE TO RELATED PATENT APPLICATIONS

This application is a U.S. National Phase Application under 35 U.S.C. § 371 of International Patent Application No. PCT/JP2021/024797 filed on Jun. 30, 2021 and claims the benefit of priority to Japanese Patent Applications No. 2020-112695 filed on Jun. 30, 2020, No. 2020-112927 filed on Jun. 30, 2020 and No. 2021-091161 filed on May 31, 2021, the contents of all of which are incorporated herein by reference in their entireties. The International Application was published in Japanese on Jan. 6, 2022 as International Publication No. WO/2022/004803 under PCT Article 21(2).

### FIELD OF THE INVENTION

The present invention relates to a copper alloy plastically-worked material suitable for a component for electronic/electrical devices such as a terminal, a copper alloy rod material, a component for electronic/electrical devices, and a terminal.

### BACKGROUND OF THE INVENTION

In the related art, copper materials have been used as electrical conductors in various fields. In recent years, large-sized terminals consisting of rod materials have also been used.

With an increase in current of electronic devices and electrical devices, in order to reduce the current density and diffuse heat due to Joule heat generation, a pure copper material such as oxygen-free copper with excellent electrical conductivity is applied to a component for electronic/electrical devices used for such electronic devices and electrical devices.

In recent years, the amount of current in a case of electrical conduction increases in a copper rod material used for a component for electronic/electrical devices. With an increase in the amount of heat generation in a case of electrical conduction and an increase in temperature in a use environment, there is a demand for a copper material with excellent heat resistance indicating that the hardness is unlikely to decrease at a high temperature. However, a pure copper material has a problem in that the material cannot be used in a high-temperature environment due to insufficient heat resistance indicating that the strength is unlikely to decrease at a high temperature.

Therefore, Japanese Unexamined Patent Application, First Publication No. 2016-056414 discloses a copper rolled plate containing 0.005% by mass or greater and less than 0.1% by mass of Mg.

The copper rolled plate described in Japanese Unexamined Patent Application, First Publication No. 2016-056414 has a composition formed of 0.005% by mass or greater and less than 0.1% by mass of Mg and the balance consisting of Cu and inevitable impurities, and thus the strength and the stress relaxation resistance can be improved by dissolving Mg into the matrix of copper without greatly decreasing the electrical conductivity.

### CITATION LIST

### Patent Document

[Patent Document 1]

Japanese Unexamined Patent Application, First Publication No. 2016-056414

### Technical Problem

Meanwhile, recently, a copper material constituting the component for electronic/electrical devices is required to further improve the electrical conductivity so that the copper material can be used for applications where the pure copper material has been used, in order to sufficiently suppress heat generation in a case where a high current flows.

Further, in the above-described large-sized terminal, since a high current flows, a decrease in volume of the entire component has been attempted by performing strict plastic working (such as bending or flanging) while the cross-sectional area of the copper rod material is maintained. Therefore, the above-described copper rod material is required to have excellent workability.

Further, with heat generation in a case of electrical conduction and an increase in temperature in a use environment, there is a demand for the component for electronic/electrical devices to be formed of a copper material with excellent heat resistance indicating that the strength is unlikely to decrease at a high temperature. Accordingly, there is a demand for a copper alloy plastically-worked material with excellent heat resistance which enables the material to be used in a high-temperature environment even after working.

Further, the copper material can be satisfactorily used by sufficiently improving the electrical conductivity even in the applications where a pure copper material has been used in the related art.

The present invention has been made in view of the above-described circumstances, and an objective of the present invention is to provide a copper alloy plastically-worked material, a copper alloy rod material, a component for electronic/electrical devices, and a terminal, which have high electrical conductivity, excellent workability, and excellent heat resistance even after application of working.

### SUMMARY OF THE INVENTION

### Solution to Problem

As a result of intensive research conducted by the present inventors in order to achieve the above-described objective, the present inventors found that addition of a small amount of Mg and regulation of the amount of an element generating a compound with Mg are required to achieve the balance between the electrical conductivity and the heat resistance. That is, the present inventors found that the electrical conductivity and the heat resistance can be further improved more than before in a well-balanced manner by regulating the amount of an element generating a compound with Mg and allowing the small amount of Mg that has been added to be present in the copper alloy in an appropriate form.

The present invention has been made based on the above-described findings. According to an aspect of the present invention, there is provided a copper alloy plastically-worked material which has a composition including greater than 10 mass ppm and 100 mass ppm or less of Mg and a balance consists of Cu and inevitable impurities, in which in the inevitable impurities, the amount of S is 10 mass ppm or less, the amount of P is 10 mass ppm or less, the amount of Se is 5 mass ppm or less, the amount of Te is 5 mass ppm or less, the amount of Sb is 5 mass ppm or less, the amount of Bi is 5 mass ppm or less, and the amount of As is 5 mass ppm or less, with a total amount of S, P, Se, Te, Sb, Bi, and As being 30 mass ppm or less, in a case where the amount of Mg is defined as [Mg] and the total amount of S, P, Se, Te, Sb, Bi, and As is defined as [S+P+Se+Te+Sb+Bi+As], a mass ratio of [Mg]/[S+P+Se+Te+Sb+Bi+As] is 0.6 or greater and 50 or less, an electrical conductivity is 97% IACS or greater, and a tensile strength is 275 MPa or less, and the heat-resistant temperature after application of draw working with a cross section reduction ratio of 25% is 150° C. or higher.

Further, the tensile strength is preferably 250 MPa or less.

According to the copper alloy plastically-worked material with the above-described configuration, since the amount of Mg and the contents of S, P, Se, Te, Sb, Bi, and As, which are elements generating compounds with Mg, are defined as described above, the heat resistance can be improved by dissolving a small amount of added Mg into the matrix of copper without greatly decreasing the electrical conductivity, specifically, the electrical conductivity can be set to 97% IACS or greater, and the heat-resistant temperature after application of draw working with a cross section reduction ratio of 25% can be set to 150° C. or higher.

Further, in the present invention, the heat-resistant temperature is a heat treatment temperature, at which a strength reaches 0.8×T₀ with respect to a strength T₀ before a heat treatment, after the heat treatment for a heat treatment time of 60 minutes.

In addition, since the tensile strength is set to 275 MPa or less, the workability is excellent, and strict plastic working can be performed.

Here, in the copper alloy plastically-worked material of the present invention, it is preferable that the cross-sectional area of the cross section transverse to the longitudinal direction of the copper alloy plastically-worked material is set to be in a range of 5 mm² or greater and 2,000 mm² or less.

In this case, since the cross-sectional area of the cross section transverse to the longitudinal direction of the copper alloy plastically-worked material is set to be in a range of 5 mm² or greater and 2,000 mm² or less, the heat capacity is increased, and thus an increase in temperature due to heat generated by electrical conduction can be suppressed.

Further, in the copper alloy plastically-worked material of the present invention, it is preferable that the total elongation is 20% or greater.

In this case, since the total elongation is set to 20% or greater, the workability is particularly excellent, and stricter plastic working can be performed.

Further, in the copper alloy plastically-worked material of the present invention, it is preferable that the amount of Ag is set to be in a range of 5 mass ppm or greater and 20 mass ppm or less.

In this case, since the amount of Ag is in the above-described range, Ag is segregated in the vicinity of grain boundaries, grain boundary diffusion is suppressed, and the heat resistance after working can be further improved.

Further, in the copper alloy plastically-worked material of the present invention, it is preferable that in the inevitable impurities, the amount of H is 10 mass ppm or less, the amount of O is 100 mass ppm or less, and the amount of C is 10 mass ppm or less.

In this case, since the contents of H, O, and C are defined as described above, generation of defects such as blowholes, Mg oxides, C involvement, and carbides can be reduced, and the heat resistance after working can be improved without decreasing the workability.

Furthermore, in the copper alloy plastically-worked material of the present invention, in a case where a measurement area of 10,000 μm² or greater in a cross section transverse to a longitudinal direction of the copper alloy plastically-worked material is ensured and defined as an observation surface of an EBSD method, a measurement point where a CI value at every measurement interval of 0.25 μm is 0.1 or less is removed, the orientation difference between crystal grains is analyzed, a boundary having 15° or greater of an orientation difference between neighboring measurement points is assigned as a crystal grain boundary, an average grain size A is acquired according to Area Fraction, measurement is performed at every measurement interval which is 1/10 or less of the average grain size A, a measurement area of 10,000 μm² or greater in a plurality of visual fields is ensured such that a total of 1,000 or more crystal grains are included, and defined as an observation surface, a measurement point where a CI value analyzed by data analysis software OIM is 0.1 or less is removed, the orientation difference between crystal grains is analyzed, and a boundary having 5° or greater of the orientation difference between neighboring pixels is assigned as a crystal grain boundary, it is preferable that the average value of Kernel Average Misorientation (KAM) values is 1.8 or less.

In this case, since the average value of the KAM values described above is set to 1.8 or less, the region with a high density of dislocations (GN dislocations) introduced during working is reduced, elongation can be ensured, and the workability can be further improved. Further, high-speed diffusion of atoms via the dislocations as a path can be suppressed, a softening phenomenon due to recovery and recrystallization can be suppressed, and the heat resistance after working can be further improved.

Further, in the copper alloy plastically-worked material of the present invention, in a cross section transverse to a longitudinal direction of the copper alloy plastically-worked material, it is preferable that the area ratio of crystals having (100) plane orientation is 3% or greater and that the area ratio of crystals having (123) plane orientation is 70% or less.

In this case, in the cross section transverse to the longitudinal direction of the copper alloy plastically-worked material, since the area ratio of crystals having the (100) plane orientation in which dislocations are unlikely to be accumulated is ensured to 3% or greater and the area ratio of crystals having the (123) plane orientation in which dislocations are likely to be accumulated is limited to 70% or less, elongation can be ensured by suppressing an increase in dislocation density, the workability can be further improved, and the heat resistance after working can be further improved.

Further, in the copper alloy plastically-worked material of the present invention, in a cross section transverse to a longitudinal direction of the copper alloy plastically-worked material, it is preferable that a crystal grain size of a surface layer region of greater than 200 μm to 1000 μm from an outer surface toward a center is in a range of 1 μm or greater and 120 μm or less.

In this case, since the crystal grain size of the surface layer region is set to 1 μm or greater, occurrence of high-speed diffusion of atoms due to grain boundary diffusion via the grain boundaries as a path can be suppressed, and the heat resistance after working can be further improved. In addition, since the crystal grain size of the surface layer region is set to 120 μm or less, elongation is ensured, and the workability can be further improved.

A copper alloy rod material of the present invention consists of the copper alloy plastically-worked material described above, in which a diameter of a cross section transverse to a longitudinal direction of the copper alloy plastically-worked material is in a range of 3 mm or greater and 50 mm or less.

According to the copper alloy rod material with the above-described configuration, since the copper alloy rod material is formed of the copper alloy plastically-worked material described above, the copper alloy rod material can exhibit excellent characteristics even for high-current applications in a high-temperature environment. Further, since the diameter of the cross section transverse to the longitudinal direction of the copper alloy plastically-worked material is set to be in a range of 3 mm or greater and 50 mm or less, the strength and the electrical conductivity can be sufficiently ensured.

A component for electronic/electrical devices of the present invention consists of the copper alloy plastically-worked material described above.

The component for electronic/electrical devices with the above-described configuration is produced by using the above-described copper alloy plastically-worked material, and thus the component can exhibit excellent characteristics even in a case of being used for high-current applications in a high-temperature environment.

A terminal of the present invention consists of the copper alloy plastically-worked material described above.

The terminal with the above-described configuration is produced by using the copper alloy plastically-worked material described above, and thus the terminal can exhibit excellent characteristics even in a case of being used for high-current applications in a high-temperature environment.

### Advantageous Effects of Invention

According to the present invention, it is possible to provide a copper alloy plastically-worked material, a copper alloy rod material, a component for electronic/electrical devices, and a terminal, which have high electrical conductivity, excellent workability, and excellent heat resistance even after application of working.

### BRIEF DESCRIPTION OF THE DRAWING

The FIGURE is a flow chart showing a method of producing a copper alloy plastically-worked material according to the present embodiment.

### DETAILED DESCRIPTION OF THE INVENTION

Hereinafter, a copper alloy plastically-worked material according to an embodiment of the present invention will be described.

The copper alloy plastically-worked material of the present embodiment has a composition including greater than 10 mass ppm and 100 mass ppm or less of Mg and a balance consisting of Cu and inevitable impurities, in which in the inevitable impurities, the amount of S is 10 mass ppm or less, the amount of P is 10 mass ppm or less, the amount of Se is 5 mass ppm or less, the amount of Te is 5 mass ppm or less, the amount of Sb is 5 mass ppm or less, the amount of Bi is 5 mass ppm or less, and the amount of As is 5 mass ppm or less, with a total amount of S, P, Se, Te, Sb, Bi, and As being 30 mass ppm or less.

Further, in a case where the amount of Mg is defined as [Mg] and the total amount of S, P, Se, Te, Sb, Bi, and As is defined as [S+P+Se+Te+Sb+Bi+As], the mass ratio of [Mg]/[S+P+Se+Te+Sb+Bi+As] is 0.6 or greater and 50 or less.

Further, in the copper alloy plastically-worked material according to the present embodiment, the amount of Ag may be in a range of 5 mass ppm or greater and 20 mass ppm or less.

Further, in the copper alloy plastically-worked material according to the present embodiment, in the inevitable impurities, the amount of H may be 10 mass ppm or less, the amount of O may be 100 mass ppm or less, and the amount of C may be 10 mass ppm or less.

Further, in the copper alloy plastically-worked material according to the present embodiment, the electrical conductivity is set to 97% IACS or greater, and the tensile strength is set to 275 MPa or less.

Further, in the copper alloy plastically-worked material according to the present embodiment, the heat-resistant temperature after application of draw working with a cross section reduction ratio of 25% is 150° C. or higher.

In addition, in the copper alloy plastically-worked material of the present embodiment, a measurement area of 10,000 μm² or greater in a cross section transverse to a longitudinal direction of the copper alloy plastically-worked material is ensured and defined as an observation surface of an electron back scattered diffraction (EBSD) method, a measurement point where a confidence index (CI) value at every measurement interval of 0.25 μm is 0.1 or less is removed, an orientation difference between crystal grains is analyzed, a boundary having 15° or greater of an orientation difference between neighboring measurement points is assigned as a crystal grain boundary, and an average grain size A is acquired according to Area Fraction. Next, in a case where the cross section transverse to the longitudinal direction of the copper alloy plastically-worked material is observed similarly by the EBSD method, measurement is performed at every measurement interval which is 1/10 or less of the average grain size A, a measurement area of 10,000 μm² or greater in a plurality of visual fields is ensured such that a total of 1,000 or more crystal grains are included and defined as an observation surface, a measurement point where a CI value analyzed by data analysis software OIM is 0.1 or less is removed, an orientation difference between crystal grains is analyzed, and a boundary having 5° or greater of an orientation difference between neighboring pixels is assigned as a crystal grain boundary, the average value of Kernel Average Misorientation (KAM) values is preferably 1.8 or less.

In addition, the average grain size A is an area average grain size.

Further, in the copper alloy plastically-worked material of the present embodiment, in the cross section transverse to the longitudinal direction of the copper alloy plastically-worked material, it is preferable that the area ratio of crystals having (100) plane orientation is set to 3% or greater and that the area ratio of crystals having (123) plane orientation is set to 70% or less.

Further, in the copper alloy plastically-worked material of the present embodiment, in the cross section transverse to the longitudinal direction of the copper alloy plastically-worked material, it is preferable that the crystal grain size of a surface layer region of greater than 200 μm to 1,000 μm from an outer surface toward a center is set to be in a range of 1 μm or greater and 120 μm or less.

Further, in the copper alloy plastically-worked material of the present embodiment, it is preferable that the cross-sectional area of the cross section transverse to the longitudinal direction of the copper alloy plastically-worked material is set to be in a range of 5 mm² or greater and 2,000 mm² or less.

Further, the copper alloy plastically-worked material of the present embodiment may be a copper alloy rod material in which the diameter of the cross section transverse to the longitudinal direction of the copper alloy plastically-worked material is set to be in a range of 3 mm or greater and 50 mm or less.

Next, in the copper alloy plastically-worked material of the present embodiment, the reason why the component composition, various characteristics, the crystal structure, and the cross-sectional area are specified as described above will be described.

(Mg)

Mg is an element having an effect of improving the heat resistance without greatly decreasing the electrical conductivity by being dissolved into the matrix of copper even after application of drawing with a cross section reduction ratio of 25%.

Here, in a case where the amount of Mg is 10 mass ppm or less, there is a concern that the effect may not be sufficiently exhibited. On the contrary, in a case where the amount of Mg is greater than 100 mass ppm, the electrical conductivity may be decreased.

As described above, in the present embodiment, the amount of Mg is set to be in a range of greater than 10 mass ppm and 100 mass ppm or less.

Further, in order to further improve the heat resistance after working, the lower limit of the amount of Mg is set to preferably 20 mass ppm or greater, more preferably 30 mass ppm or greater, and still more preferably 40 mass ppm or greater.

Further, in order to further suppress a decrease in the electrical conductivity, the upper limit of the amount of Mg is set to preferably less than 90 mass ppm, more preferably less than 80 mass ppm, and still more preferably less than 70 mass ppm.

(S, P, Se, Te, Sb, Bi, and As)

The elements such as S, P, Se, Te, Sb, Bi, and As described above are elements that typically exist in a copper alloy. These elements are likely to react with Mg to form a compound, and thus may reduce the solid-solution effect of a small amount of added Mg. Therefore, the amount of these elements is required to be strictly controlled.

Therefore, in the present embodiment, the amount of S is limited to 10 mass ppm or less, the amount of P is limited to 10 mass ppm or less, the amount of Se is limited to 5 mass ppm or less, the amount of Te is limited to 5 mass ppm or less, the amount of Sb is limited to 5 mass ppm or less, the amount of Bi is limited to 5 mass ppm or less, and the amount of As is limited to 5 mass ppm or less.

Further, the total amount of S, P, Se, Te, Sb, Bi, and As is limited to 30 mass ppm or less.

Further, the amount of S is preferably 9 mass ppm or less and more preferably 8 mass ppm or less.

The amount of P is preferably 6 mass ppm or less and more preferably 3 mass ppm or less.

The amount of Se is preferably 4 mass ppm or less and more preferably 2 mass ppm or less.

The amount of Te is preferably 4 mass ppm or less and more preferably 2 mass ppm or less.

The amount of Sb is preferably 4 mass ppm or less and more preferably 2 mass ppm or less.

The amount of Bi is preferably 4 mass ppm or less and more preferably 2 mass ppm or less.

The amount of As is preferably 4 mass ppm or less and more preferably 2 mass ppm or less.

The lower limit of the amount of the above-described elements is not particularly limited, but the amount of each of S, P, Sb, Bi, and As is preferably 0.1 mass ppm or greater, the amount of Se is preferably 0.05 mass ppm or greater, and the amount of Te is preferably 0.01 mass ppm or greater from the viewpoint that the production cost is increased in order to greatly reduce the amount of the above-described elements.

Further, the total amount of S, P, Se, Te, Sb, Bi, and As is preferably 24 mass ppm or less and more preferably 18 mass ppm or less. The lower limit of the total amount of S, P, Se, Te, Sb, Bi, and As is not particularly limited, but the total amount of S, P, Se, Te, Sb, Bi, and As is 0.6 mass ppm or greater and more preferably 0.8 mass ppm or greater from the viewpoint that the production cost is increased in order to greatly reduce the total amount of S, P, Se, Te, Sb, Bi, and As.

([Mg]/[S+P+Se+Te+Sb+Bi+As])

As described above, since elements such as S, P, Se, Te, Sb, Bi, and As easily react with Mg to form compounds, the form of presence of Mg is controlled by defining the ratio between the amount of Mg and the total amount of S, P, Se, Te, Sb, Bi, and As in the present embodiment.

In a case where the amount of Mg is defined as [Mg] and the total amount of S, P, Se, Te, Sb, Bi, and As is defined as [S+P+Se+Te+Sb+Bi+As], Mg is excessively present in copper in a solid solution state, and thus the electrical conductivity may be decreased in a case where the mass ratio of [Mg]/[S+P+Se+Te+Sb+Bi+As] is greater than 50. On the contrary, in a case where the mass ratio of [Mg]/[S+P+Se+Te+Sb+Bi+As] is less than 0.6, Mg is not sufficiently dissolved into copper, and thus the heat resistance may not be sufficiently improved.

Therefore, in the present embodiment, the mass ratio of [Mg]/[S+P+Se+Te+Sb+Bi+As] is set to be in a range of 0.6 or greater and 50 or less.

In addition, the amount of each element in the above-described mass ratio is in units of mass ppm.

In order to further suppress a decrease in electrical conductivity, the upper limit of the mass ratio of [Mg]/[S+P+Se+Te+Sb+Bi+As] is preferably 35 or less and more preferably 25 or less.

Further, in order to further improve the heat resistance, the lower limit of the mass ratio of [Mg]/[S+P+Se+Te+Sb+Bi+As] is set to preferably 0.8 or greater and more preferably 1.0 or greater.

(Ag: 5 mass ppm or greater and 20 mass ppm or less)

Ag is unlikely to be dissolved into the Cu matrix in a temperature range of 250° C. or lower, in which typical electronic/electrical devices are used. Therefore, a small amount of Ag added to copper segregates in the vicinity of grain boundaries. In this manner, since movement of atoms at grain boundaries is disturbed and grain boundary diffusion is suppressed, the heat resistance after working is improved.

Here, in a case where the amount of Ag is 5 mass ppm or greater, the effects can be sufficiently exhibited. On the contrary, in a case where the amount of Ag is 20 mass ppm or less, the electrical conductivity can be ensured and an increase in production cost can be suppressed.

As described above, in the present embodiment, the amount of Ag is set to be in a range of 5 mass ppm or greater and 20 mass ppm or less.

In order to further improve the heat resistance after working, the lower limit of the amount of Ag is set to preferably 6 mass ppm or greater, more preferably 7 mass ppm or greater, and still more preferably 8 mass ppm or greater. Further, in order to reliably suppress a decrease in the electrical conductivity and an increase in cost, the upper limit of the amount of Ag is set to preferably 18 mass ppm or less, more preferably 16 mass ppm or less, and still more preferably 14 mass ppm or less.

Further, in a case where Ag is not intentionally included and the impurities include Ag, the amount of Ag may be less than 5 mass ppm.

(H: 10 mass ppm or less)

H is an element that combines with O to form water vapor in a case of casting and causes blowhole defects in an ingot. The blowhole defects cause defects such as breaking in a case of casting and blistering and peeling in a case of working. The defects such as breaking, blistering, and peeling are known to degrade the strength and the surface quality because the defects are the starting point of fractures due to stress concentration.

Here, the occurrence of blowhole defects described above is suppressed by setting the amount of H to 10 mass ppm or less, and deterioration of cold workability can be suppressed.

In order to further suppress the occurrence of blowhole defects, the amount of H is set to preferably 4 mass ppm or less and more preferably 2 mass ppm or less. The lower limit of the amount of H is not particularly limited, but the amount of H is preferably 0.01 mass ppm or greater from the viewpoint that the production cost is increased in order to greatly reduce the amount of H.

(O: 100 mass ppm or less)

O is an element that reacts with each component element in the copper alloy to form an oxide. Since such oxides serve as the starting point for fractures, workability is degraded, which makes the production difficult. Further, in a case where an excessive amount of O reacts with Mg, Mg is consumed, the amount of solid solution of Mg into the Cu matrix is decreased, and thus the strength, the heat resistance, or the cold workability may be degraded.

Here, the generation of oxides and the consumption of Mg are suppressed by setting the amount of O to 100 mass ppm or less, and thus the workability can be improved.

Further, the amount of O is particularly preferably 50 mass ppm or less and more preferably 20 mass ppm or less, even within the above-described range. The lower limit of the amount of O is not particularly limited, but the amount of O is preferably 0.01 mass ppm or greater from the viewpoint that the production cost is increased in order to greatly reduce the amount of 0.

(C: 10 mass ppm or less)

C is an element that is used to coat the surface of a molten metal in a case of melting and casting for the objective of deoxidizing the molten metal and thus may inevitably be mixed. The amount of C may increase due to C inclusion during casting. The segregation of C, a composite carbide, and a solid solution of C degrades the cold workability.

Here, in a case where the amount of C is set to 10 mass ppm or less, occurrence of segregation of C, a composite carbide, and a solid solution of C can be suppressed, and cold workability can be improved. Further, the amount of C is set to preferably 5 mass ppm or less and more preferably 1 mass ppm or less, even within the above-described range. The lower limit of the amount of C is not particularly limited, but the amount of C is preferably 0.01 mass ppm or greater from the viewpoint that the production cost is increased in order to greatly reduce the amount of C.

(Other Inevitable Impurities)

Examples of other inevitable impurities in addition to the above-described elements include Al, B, Ba, Be, Ca, Cd, Cr, Sc, rare earth elements, V, Nb, Ta, Mo, Ni, W, Mn, Re, Ru, Sr, Ti, Os, Co, Rh, Ir, Pb, Pd, Pt, Au, Zn, Zr, Hf, Hg, Ga, In, Ge, Y, Tl, N, Si, Sn, and Li. The copper alloy may contain inevitable impurities within a range not affecting the characteristics.

Here, since there is a concern that the electrical conductivity is decreased, it is preferable that the amount of the inevitable impurities is reduced.

(Tensile Strength: 275 MPa or Less)

In the copper alloy plastically-worked material of the present embodiment, in a case where the tensile strength in a direction parallel to the longitudinal direction (wire-drawing direction) of the copper alloy plastically-worked material is 275 MPa or less, elongation is ensured, and the workability can be improved.

Further, the upper limit of the tensile strength in the direction parallel to the longitudinal direction (wire-drawing direction) of the copper alloy plastically-worked material is more preferably 270 MPa or less, still more preferably 260 MPa or less, and most preferably 250 MPa or less. Further, the upper limit of the tensile strength may be 240 MPa or less, 230 MPa or less, or 220 MPa or less. Further, the lower limit of the tensile strength in the direction parallel to the longitudinal direction (wire-drawing direction) of the copper alloy plastically-worked material is preferably 100 MPa or greater, more preferably 120 MPa or greater, and still more preferably 140 MPa or greater.

(Electrical Conductivity: 97% IACS or Greater)

In the copper alloy plastically-worked material according to the present embodiment, the electrical conductivity is 97% IACS or greater. The heat generation in a case of electrical conduction is suppressed by setting the electrical conductivity to 97% IACS or greater so that the copper alloy plastically-worked material can be satisfactorily used as a component for electronic/electrical devices such as a terminal as a substitute to a pure copper material.

Further, the electrical conductivity is preferably 97.5% IACS or greater, more preferably 98.0% IACS or greater, still more preferably 98.5% IACS or greater, and even still more preferably 99.0% IACS or greater. The upper limit of the electrical conductivity is not particularly limited, but is preferably 103.0% IACS or less and more preferably 102.5% IACS or less.

(Heat-Resistant Temperature after Working: 150° C. or Higher)

In the copper alloy plastically-worked material of the present embodiment, in a case where the heat-resistant temperature after application of draw working with a cross section reduction ratio of 25% is high, since a softening phenomenon due to recovery and recrystallization of the copper material is unlikely to occur even at a high temperature, the copper alloy plastically-worked material can be applied to an electric conductive member used in a high-temperature environment.

Therefore, in the present embodiment, the heat-resistant temperature after working is set to 150° C. or higher. Further, in the embodiment, the heat-resistant temperature is a heat treatment temperature, at which a strength reaches 0.8×T₀ with respect to a strength T₀ before a heat treatment, after the heat treatment at 100° C. to 800° C. for a heat treatment time of 60 minutes.

Here, the heat-resistant temperature after application of draw working with a cross section reduction ratio of 25% is more preferably 175° C. or higher, still more preferably 200° C. or higher, and even still more preferably 225° C. or higher. In addition, the heat-resistant temperature is preferably 600° C. or lower and more preferably 580° C. or lower.

(Total Elongation: 20% or Greater)

In the copper alloy plastically-worked material according to the present embodiment, in a case where the total elongation is 20% or greater, the workability is further excellent, and components can be molded by plastic working under strict conditions.

Further, the total elongation is more preferably 22.5% or greater and more preferably 25% or greater. Further, the total elongation is preferably 60% or less and more preferably 55% or less.

The total elongation is the total elongation at break (%) described in 3.4.3 of JIS Z 2241. That is, the total elongation is the total elongation at break (combination of elastic elongation and plastic elongation of an extensometer), which is a value expressed as a percentage of the gauge length of an extensometer.

(Average Value of KAM Values: 1.8 or Less)

The Kernel Average Misorientation (KAM) value measured by the EBSD method is a value calculated by averaging the orientation differences between one pixel and pixels surrounding the pixel. Since the shape of the pixel is a regular hexagon, in a case where the degree of proximity is set to 1 (1st), the average value of the orientation differences between six adjacent pixels is calculated as the KAM value. By using this KAM value, the distribution of the local orientation difference, that is, the strain can be visualized.

Since a region with a high KAM value is a region with a high density of dislocations (GN dislocations) introduced during working, the strength increases and the elongation decreases. Further, the dislocation density further increases after application of draw working with a cross section reduction ratio of 25%, high-speed diffusion of atoms via the dislocations as a path is likely to occur, the softening phenomenon due to recovery and recrystallization is likely to occur, and thus the heat resistance is degraded.

Therefore, in a case where the average value of the KAM values is controlled to 1.8 or less, the strength can be decreased, the elongation can be improved, and thus the heat-resistant temperature after working can be further improved.

Further, the average value of the KAM values is preferably 1.6 or less, more preferably 1.4 or less, still more preferably 1.2 or less, and even still more preferably 1.0 or less, even within the above-described range The average value of the KAM values is preferably 0.2 or greater, more preferably 0.4 or greater, still more preferably 0.6 or greater, and most preferably 0.8 or greater.

In addition, in the present embodiment, the KAM value is calculated except for the measurement points where the confidence index (CI) value, which is the value measured by the analysis software OIM Analysis (Ver.7.3.1) of an EBSD device, is 0.1 or less. The CI value is calculated by using a Voting method in a case of indexing the EBSD pattern obtained from a certain analysis point, and a value from 0 to 1 is employed as the CI value. Since the CI value is a value for evaluating the reliability of the indexing and the orientation calculation, in a case where the CI value is small, that is, in a case where a crystal pattern with clear analysis points cannot be obtained, it can be said that strain (worked texture) is present in the texture. Particularly in a case where the strain is large, a value of 0.1 or less is employed as the CI value.

(Area Ratio of Crystals Having (100) Plane Orientation: 3% or Greater)

In the copper alloy plastically-worked material of the present embodiment, in a case where the crystal orientation in a cross section transverse to the longitudinal direction (wire-drawing direction) of the copper alloy plastically-worked material is measured, the area ratio of crystals having (100) plane orientation is preferably 3% or greater. In the present embodiment, the crystal orientation within 15° from the (100) plane is defined as the (100) plane orientation.

Since dislocations in a case of crystal grains having the (100) plane orientation are less likely to be accumulated than those of crystal grains in another orientation, elongation can be improved by ensuring that the area ratio of crystals having the (100) plane orientation is 3% or greater. Further, since the (100) plane is unlikely to accumulate dislocations and rotation of the crystal orientation due to working is unlikely to occur, in a case of working with a cross section reduction ratio of 25%, the (100) plane can be maintained even after working, the high-speed diffusion via dislocations as a diffusion path can be suppressed, the softening phenomenon due to recovery and recrystallization can be suppressed, and the heat resistance after working can be improved.

Further, the area ratio of crystals having the (100) plane orientation is more preferably 4% or greater, still more preferably 6% or greater, even still more preferably 10% or greater, and even still more preferably 20% or greater. Further, in a case where the area ratio of crystals having the (100) plane orientation is extremely high, since the number of crystal grains in the same crystal orientation as described above increases, the number of large-angle grain boundaries may be decreased and elongation may be reduced. Therefore, the area ratio of crystals having the (100) plane orientation is preferably 80% or less, more preferably 70% or less, still more preferably 60% or less, and even still more preferably 50% or less.

(Area Ratio of Crystals Having (123) Plane Orientation: 70% or Less)

In the copper alloy plastically-worked material of the present embodiment, in a case where the crystal orientation in a cross section transverse to the longitudinal direction (wire-drawing direction) of the copper alloy plastically-worked material is measured, the area ratio of crystals having (123) plane orientation is preferably 70% or less. Further, in the present embodiment, the crystal orientation within 15° from the (123) plane is defined as the (123) plane orientation.

Since dislocations in a case of crystal grains having the (123) plane orientation are likely to be accumulated than those of crystal grains in another orientation, elongation can be improved by ensuring that the area ratio of crystals having the (123) plane orientation is limited to 70% or less.

The area ratio of crystals having the (123) plane orientation is more preferably 65% or less, still more preferably 60% or less, even still more preferably 55% or less, and even still more preferably 50% or less.

Further, the area ratio of crystals having the (123) plane orientation is preferably 10% or greater.

(Crystal Grain Size in Surface Layer Region)

In the copper alloy plastically-worked material according to the present embodiment, in a case where the crystal grain size of a surface layer region of greater than 200 μm to 1,000 μm from the outer surface toward the center is set to 1 μm or greater in a cross section transverse to a longitudinal direction of the copper alloy plastically-worked material, the occurrence of high-speed diffusion of atoms due to grain boundary diffusion via grain boundaries as a path can be suppressed, and the heat resistance after working can be further improved. In addition, since the crystal grain size of the surface layer region is set to 120 μm or less, elongation is ensured, and the workability can be further improved.

The crystal grain size of the surface layer region is more preferably 2 μm or greater, still more preferably 5 μm or greater, and even still more preferably 10 μm or greater. In addition, the crystal grain size of the surface layer region is more preferably 100 μm or less, still more preferably 70 μm or less, and even still more preferably 50 μm or less.

Here, the crystal grain is a crystal grain having a boundary where the orientation difference between neighboring pixels detected by the above-described EBSD method is 15° or greater, as the crystal grain boundary.

(Cross-Sectional Area: 5 mm² or Greater and 2,000 mm² or Less)

In the copper alloy plastically-worked material according to the present embodiment, in a case where the cross-sectional area of a cross section transverse to the longitudinal direction of the copper alloy plastically-worked material is in a range of 5 mm² or greater and 2,000 mm² or less, the heat capacity is increased, and thus an increase in temperature due to heat generated by electrical conduction can be suppressed even in a case where a high current flows.

Further, the cross-sectional area of the cross section transverse to the longitudinal direction of the copper alloy plastically-worked material is more preferably 6.0 mm² or greater, still more preferably 7.5 mm² or greater, and even still more preferably 10 mm² or greater. Further, the cross-sectional area of the cross section transverse to the longitudinal direction of the copper alloy plastically-worked material is more preferably 1,800 mm² or less, still more preferably 1,600 mm² or less, and even still more preferably 1,500 mm² or less.

Next, a method of producing the copper alloy plastically-worked material according to the present embodiment with such a configuration will be described with reference to the flow chart of the drawing.

(Melting and Casting Step S01)

First, the above-described elements are added to molten copper obtained by melting the copper raw material to adjust components; and thereby, a molten copper alloy is produced. Further, a single element, a base alloy, or the like can be used for addition of various elements. In addition, raw materials containing the above-described elements may be melted together with the copper raw material. Further, a recycled material or a scrap material of the alloy may be used.

As the copper raw material, so-called 4N Cu having a purity of 99.99% by mass or greater or so-called 5N Cu having a purity of 99.999% by mass or greater is preferably used. In a case where the contents of H, O, and C are defined as described above, raw material with low contents of these elements is selected and used. Specifically, it is preferable to use a raw material having 0.5 mass ppm or less of H, 2.0 mass ppm or less of O, and 1.0 mass ppm or less of C.

In order to suppress oxidation of Mg and to reduce the hydrogen concentration in a case of melting, it is preferable that the melting is carried out in an atmosphere using an inert gas atmosphere (for example, Ar gas) in which the vapor pressure of H₂O is low and the holding time for the melting is set to the minimum.

Further, the molten copper alloy in which the components have been adjusted is injected into a mold to produce an ingot. In consideration of mass production, it is preferable to use a continuous casting method or a semi-continuous casting method.

(Homogenizing/Solutionizing Step S02)

Next, a heat treatment is performed for homogenization and solutionization of the obtained ingot. An intermetallic compound or the like containing Cu and Mg as main components may be present inside the ingot, generated by segregation and concentration of Mg in the solidification process. Therefore, in order to eliminate or reduce the segregated elements and the intermetallic compound, Mg is homogeneously diffused or Mg is dissolved into the matrix in the ingot by performing a heat treatment of heating the ingot to 300° C. or higher and 1,080° C. or lower. In addition, it is preferable that the homogenizing/solutionizing step S02 is performed in a non-oxidizing or reducing atmosphere.

Here, in a case where the heating temperature is lower than 300° C., the solutionization may be incomplete, and a large amount of the intermetallic compound containing Cu and Mg as main components may remain in the matrix. On the contrary, in a case where the heating temperature is higher than 1,080° C., a part of the copper material serves a liquid phase, and thus the texture and the surface state may be uneven. Therefore, the heating temperature is set to be in a range of 300° C. or higher and 1,080° C. or lower.

(Hot Working Step S03)

The obtained ingot is heated to a predetermined temperature and subjected to hot working in order to homogenize the texture. The working method is not particularly limited, and for example, drawing, extrusion, or groove rolling can be employed. In the present embodiment, hot extrusion working is performed.

Further, a pickling step using a pickling tank may be performed before the heat treatment step S04 described below in order to remove an oxide film generated during hot working. Moreover, peeling working may be performed to remove surface defects in a case of the rod material.

Further, the grain boundary segregation can be reduced by setting the hot working temperature and the hot working finishing temperature to be high and setting the subsequent cooling rate to be high. The cooling rate is preferably 5° C./sec or greater, more preferably 7° C./sec or greater, and still more preferably 10° C./sec or greater. In this manner, the texture (area ratio of crystals having the (100) plane orientation and the (123) plane orientation) in the heat treatment step S04 described below can be controlled.

Here, the hot working temperature is preferably 500° C. or higher, more preferably 550° C. or higher, and even still more preferably 600° C. or higher. Further, the hot working finishing temperature is preferably 400° C. or higher, more preferably 450° C. or higher, and still more preferably 500° C. or higher.

(Heat Treatment Step S04)

A heat treatment is performed after the hot working step S03.

Here, in a case where the heat treatment temperature is lower than 300° C. or the holding time is shorter than 0.5 hours, recrystallization does not sufficiently occur, the strain in the hot working step S03 remains, and thus the KAM value may increase. Further, there is a concern that the crystal grain size extremely decreases, the area ratio of crystals having the (100) plane orientation decreases, and the area ratio of crystals having the (123) plane orientation increases. In addition, in a case where the heat treatment temperature is higher than 700° C. or the holding time is longer than 24 hours, the crystal grain size increases, and the area ratio of crystals having the (100) plane orientation may extremely increase. Therefore, in the present embodiment, it is preferable that the heat treatment temperature is set to be in a range of 300° C. or greater and 700° C. or lower and that the holding time at the heat treatment temperature is set to be in a range of 0.5 hours or longer and 24 hours or shorter.

Further, the heat treatment temperature is more preferably 350° C. or higher and still more preferably 400° C. or higher. In addition, the heat treatment temperature is more preferably 650° C. or lower and still more preferably 600° C. or lower. Further, the holding time at the heat treatment temperature is more preferably 0.75 hours or longer and still more preferably 1 hour or longer. In addition, the holding time at the heat treatment temperature is more preferably 18 hours or shorter and more preferably 12 hours or shorter.

In order to reliably control the area ratio of crystals having the (100) plane orientation and the area ratio of crystals having the (123) plane orientation, the temperature increasing rate during the heat treatment carried out by continuous annealing is preferably 2° C./sec or greater, more preferably 5° C./sec or greater, and still more preferably 7° C./sec or greater. Further, the temperature decreasing rate is preferably 5° C./sec or greater, more preferably 7° C./sec or greater, and still more preferably 10° C./sec or greater.

In order to reduce oxidation of the contained elements, the oxygen partial pressure is set to preferably 10-5 atm or less, more preferably 10-7 atm or less, and still more preferably 10-9 atm or less.

(Finish Working Step S05)

After the heat treatment step S04, finish working may be performed to adjust the strength. The working method is not particularly specified, but in a case of the rod material, draw working, extrusion working, or the like can be used. Further, in the case of the rod material, a drawing step may be performed for straightening. Further, the working conditions are appropriately adjusted such that the tensile strength of the copper alloy plastically-worked material to be produced in the longitudinal direction is 275 MPa or less.

In this manner, the copper alloy plastically-worked material (copper alloy rod material) according to the present embodiment is produced.

In the copper alloy plastically-worked material according to the present embodiment with the above-described configuration, since the amount of Mg is set to be in a range of greater than 10 mass ppm and 100 mass ppm or less, and the amount of S is set to 10 mass ppm or less, the amount of P is set to 10 mass ppm or less, the amount of Se is set to 5 mass ppm or less, the amount of Te is set to 5 mass ppm or less, the amount of Sb is set to 5 mass ppm or less, the amount of Bi is set to 5 mass ppm or less, the amount of As is set to 5 mass ppm or less, and the total amount of S, P, Se, Te, Sb, Bi, and As, which are the elements generating compounds with Mg, is limited to 30 mass ppm or less, a small amount of added Mg can be dissolved into the matrix of copper, and the heat resistance after working can be improved without greatly decreasing the electrical conductivity.

Further, in a case where the amount of Mg is defined as [Mg] and the total amount of S, P, Se, Te, Sb, Bi, and As is defined as [S+P+Se+Te+Sb+Bi+As], since the mass ratio of [Mg]/[S+P+Se+Te+Sb+Bi+As] is set to be in a range of 0.6 or greater and 50 or less, the heat resistance after working can be sufficiently improved without decreasing the electrical conductivity due to dissolution of an excessive amount of Mg.

Further, since the tensile strength is set to 275 MPa or less, the workability is excellent, and strict plastic working can be performed.

In the copper alloy plastically-worked material of the present embodiment, in a case where the cross-sectional area of a cross section transverse to the longitudinal direction of the copper alloy plastically-worked material is set to be in a range of 5 mm² or greater and 2,000 mm² or less, the heat capacity increases, and an increase in temperature due to heat generated by electrical conduction can be suppressed.

Further, in the copper alloy plastically-worked material of the present embodiment, in a case where the total elongation is set to 20% or greater, the workability is particularly excellent, and strict plastic working can be performed.

Further, in the copper alloy plastically-worked material according to the present embodiment, in a case where the amount of Ag is set to be in a range of 5 mass ppm or greater and 20 mass ppm or less, since Ag is segregated in the vicinity of grain boundaries and grain boundary diffusion is suppressed by Ag, the heat resistance after working can be further improved.

Further, in the copper alloy plastically-worked material of the present embodiment, in a case where among the inevitable impurities, the amount of H is set to 10 mass ppm or less, the amount of O is set to 100 mass ppm or less, and the amount of C is set to 10 mass ppm or less, generation of defects such as blowholes, Mg oxides, C involvement, and carbides can be reduced, and the heat resistance after working can be improved without decreasing the workability.

Further, in the copper alloy plastically-worked material of the present embodiment, in a case where a measurement area of 10,000 μm² or greater in a cross section transverse to a longitudinal direction of the copper alloy plastically-worked material is ensured and defined as an observation surface of the EBSD method, a measurement point where a CI value at every measurement interval of 0.25 μm is 0.1 or less is removed, an orientation difference between crystal grains is analyzed, a boundary having 15° or greater of an orientation difference between neighboring measurement points is assigned as a crystal grain boundary, an average grain size A is acquired according to Area Fraction, measurement is performed at every measurement interval which is 1/10 or less of the average grain size A, a measurement area of 10,000 μm² or greater in a plurality of visual fields is ensured such that a total of 1,000 or more crystal grains are included and defined as an observation surface, a measurement point where a CI value analyzed by data analysis software OIM is 0.1 or less is removed, an orientation difference between crystal grains is analyzed, and a boundary having 5° or greater of an orientation difference between neighboring pixels is assigned as a crystal grain boundary, the average value of Kernel Average Misorientation (KAM) values is 1.8 or less. In this case, a region with a high density of dislocations (GN dislocations) introduced during working is reduced, elongation can be ensured, and thus the workability can be further improved. Further, high-speed diffusion of atoms via the dislocations as a path can be suppressed, a softening phenomenon due to recovery and recrystallization can be suppressed, and the heat resistance after working can be further improved.

Further, in the copper alloy plastically-worked material of the present embodiment, in a case where the area ratio of crystals having the (100) plane orientation is set to 3% or greater and the area ratio of crystals having the (123) plane orientation is set to 70% or less as a result of measurement of the crystal orientation in the cross section transverse to the longitudinal direction of the copper alloy plastically-worked material, since the area ratio of crystals having the (100) plane orientation in which dislocations are unlikely to be accumulated is ensured to 3% or greater and the area ratio of crystals having the (123) plane orientation in which dislocations are likely to be accumulated is limited to 70% or less, elongation can be ensured by suppressing an increase in dislocation density, the workability can be further improved, and the heat resistance after working can be further improved.

Further, in the copper alloy plastically-worked material of the present embodiment, in a case where the crystal grain size of a surface layer region of greater than 200 μm to 1,000 μm from the outer surface toward the center is set to 1 μm or greater in the cross section transverse to the longitudinal direction of the copper alloy plastically-worked material, the occurrence of high-speed diffusion of atoms due to grain boundary diffusion via grain boundaries as a path can be suppressed, and the heat resistance after working can be further improved. Further, in a case where the crystal grain size of the surface layer region described above is 120 μm or less, elongation is ensured, and the workability can be further improved.

Further, since the copper alloy rod material of the present embodiment is formed of the copper alloy plastically-worked material described above, excellent characteristics can be exhibited even in a case of being used for high-current applications in a high-temperature environment. Further, since the diameter of the cross section transverse to the longitudinal direction of the copper alloy plastically-worked material is set to be in a range of 3 mm or greater and 50 mm or less, the strength and the electrical conductivity can be sufficiently ensured.

Further, the component for electronic/electrical devices (such as a terminal) according to the present embodiment is formed of the above-described copper alloy plastically-worked material, and thus can exhibit excellent characteristics even in a case of being used for high-current applications in a high-temperature environment.

Hereinbefore, the copper alloy plastically-worked material and the component for electronic/electrical devices (such as a terminal) according to the embodiment of the present invention have been described, but the present invention is not limited thereto and can be appropriately changed within a range not departing from the technical features of the invention.

For example, in the above-described embodiment, the example of the method of producing the copper alloy plastically-worked material has been described, but the method of producing the copper alloy plastically-worked material is not limited to the description of the embodiment, and the copper alloy plastically-worked material may be produced by appropriately selecting a production method of the related art.

### Examples

Hereinafter, results of a verification test conducted to verify the effects of the present invention will be described.

A copper raw material in which the amount of H was 0.1 mass ppm or less, the amount of O was 1.0 mass ppm or less, the amount of S was 1.0 mass ppm or less, the amount of C was 0.3 mass ppm or less, and the purity of Cu was 99.99% by mass or greater, and a base alloy of each of various additive elements, containing 1% by mass of various additive elements prepared by using a high-purity copper with 6 N (purity of 99.9999% by mass) or greater and a pure metal with 2N (purity of 99% by mass) or greater were prepared.

The copper raw material was put into a crucible and subjected to high-frequency melting in an atmosphere furnace having an Ar gas atmosphere or an Ar—O₂ gas atmosphere.

Each component composition listed in Tables 1 and 2 was prepared using the above-described base alloy in the obtained molten copper, and in a case where H and O were introduced, the atmosphere during melting was prepared as an Ar—N₂—H₂ and Ar—O₂-mixed gas atmosphere using high-purity Ar gas (dew point of −80° C. or lower), high-purity N₂ gas (dew point of −80° C. or lower), high-purity O₂ gas (dew point of −80° C. or lower), and high-purity H₂ gas (dew point of −80° C. or lower). In a case where C was introduced, the surface of the molten metal was coated with C particles during melting and brought into contact with the molten metal.

In this manner, alloy molten metals having the component composition listed in Tables 1 and 2 were melted and poured into a carbon mold to produce an ingot. Further, the size of the ingot was set such that the diameter of the ingot was approximately 80 mm and the length of the ingot was approximately 300 mm.

The obtained ingot was subjected to the homogenizing/solutionizing step in an Ar gas atmosphere under the conditions listed in Tables 3 and 4.

Thereafter, the ingot was subjected to hot working (hot extrusion) under the conditions (the working finishing temperature and the extrusion ratio) listed in Tables 3 and 4, thereby obtaining a hot worked material. Further, the hot worked material was cooled by water cooling after the hot working.

The obtained hot worked material was subjected to a heat treatment using a salt bath under the conditions listed in Tables 3 and 4 and then cooled.

Thereafter, the copper material on which the heat treatment had been performed was cut, and the surface was ground to remove the oxide film.

Thereafter, finish working (cold extrusion working) was performed at room temperature under the conditions listed in Tables 3 and 4, thereby obtaining copper alloy plastically-worked materials (copper alloy rod materials) of examples of the present invention and comparative examples.

The obtained copper alloy plastically-worked materials (copper alloy rod materials) were evaluated for the following items.

(Composition Analysis)

A measurement specimen was collected from the obtained ingot, Mg was measured by inductively coupled plasma atomic emission spectrophotometry, and other elements were measured using a glow discharge mass spectrometer (GD-MS). Further, H was analyzed by a thermal conductivity method, and O, S, and C were analyzed by an infrared absorption method.

Further, the measurement was performed at two sites, the center portion of the specimen and the end portion of the specimen in the width direction, and the larger content was defined as the amount of the sample. As a result, it was confirmed that the component compositions were as listed in Tables 1 and 2.

(Tensile Strength and Total Elongation)

Test pieces were collected in conformity with #2 test pieces specified in JIS Z 2201, and the total elongation and the tensile strength of the copper alloy plastically-worked material (copper alloy rod material) in the longitudinal direction (extrusion direction) were measured by the tensile test method of JIS Z 2241. In a case where the cross-sectional area of the cross section transverse to the longitudinal direction of the copper alloy plastically-worked material was greater than 450 mm², the test was performed with a parallel part having a length of 200 mm in the longitudinal direction of the copper alloy plastically-worked material.

The tensile strength is the stress corresponding to the maximum tensile test force of the tensile test, and the total elongation is the total elongation at break (combination of elastic elongation and plastic elongation of an extensometer), which is a value expressed as a percentage of the gauge length of an extensometer.

(Heat-Resistant Temperature after Working)

The obtained copper alloy plastically-worked material (copper alloy rod material) was subjected to draw working with a cross section reduction ratio of 25% at room temperature.

Thereafter, the heat-resistant temperature was evaluated by obtaining an isochrone softening curve by performing a tensile test on the copper alloy plastically-worked material in the longitudinal direction (drawing direction) after one hour of the heat treatment in conformity with JCBA T325:2013 of Japan Copper and Brass Association.

In the present embodiment, the heat-resistant temperature is a heat treatment temperature, at which a strength reaches 0.8×T₀ with respect to a strength T₀ before a heat treatment, after the heat treatment at 100° C. to 800° C. for a heat treatment time of 60 minutes. Further, the strength T₀ before the heat treatment is a value measured at room temperature (15° C. to 35° C.).

(Electrical Conductivity)

The electrical conductivity was calculated in conformity with JIS H 0505 (method of measuring the volume resistivity and the electrical conductivity of a non-ferrous metal material).

(Kam Value)

The average value of the KAM values was acquired in the following manner by using a cross section transverse to the longitudinal direction (wire-drawing direction) of the copper alloy rod material (copper alloy plastically-worked material) as an observation surface with an EBSD measuring device and OIM analysis software.

The observation surface was subjected to mechanical polishing using waterproof abrasive paper and diamond abrasive grains and to finish polishing using a colloidal silica solution. Thereafter, the observation surface with a measurement area of 10,000 μm² or greater at an electron beam acceleration voltage of 15 kV was observed by an EBSD measuring device (Quanta FEG 450, manufactured by FEI, OIM Data Collection, manufactured by EDAX/TSL (currently AMETEK)) and analysis software (OIM Data Analysis ver 7.3.1, manufactured by EDAX/TSL (currently AMETEK)), a measurement point where a CI value at every measurement interval of 0.25 μm was 0.1 or less was removed, an orientation difference between crystal grains was analyzed, a boundary having 15° or greater of an orientation difference between neighboring measurement points was assigned as a crystal grain boundary, and an average grain size A was acquired according to Area Fraction using data analysis software OIM.

Thereafter, the observation surface was measured at every measurement interval which was 1/10 or less of the average grain size A, a measurement point where a CI value analyzed by data analysis software OIM was 0.1 or less was removed and analyzed in a measurement area of 10,000 μm² or greater in a plurality of visual fields such that a total of 1,000 or more crystal grains were included, the KAM values of all pixels analyzed by assigning a boundary having 5° or greater of an orientation difference between neighboring pixels as a crystal grain boundary were acquired, and the average value of the KAM values was acquired.

(Texture)

The area ratio in orientation within 15° from the (100) plane orientation and the area ratio in orientation within 15° from the (123) plane orientation were measured by an EBSD measuring device and OIM analysis software based on the above-described measured results.

(Crystal Grain Size in Surface Layer Region)

With respect to the obtained copper alloy plastically-worked material (copper alloy rod material), in the cross section transverse to the longitudinal direction (extrusion direction) of the copper alloy plastically-worked material, the average crystal grain size of a surface layer region of greater than 200 μm to 1,000 μm from the outer surface toward the center was measured. Here, the average crystal grain size is the area average crystal grain size.

The above-described average crystal grain size was calculated by measuring four points at positions of 0°, 90°, 180°, and 270° along the circumferential direction from an arbitrary axis, using this axis passing through the center of the cross section transverse to the longitudinal direction (extrusion direction) of the copper alloy plastically-worked material as a reference and averaging the crystal grain sizes at the four points. The measurement was performed such that a boundary having 15° or greater of an orientation difference between neighboring two aligned crystals was assigned as a crystal grain boundary and the weighted average value weighted by the area was assigned as a crystal grain size using SEM-EBSD (detector HIKARI, analysis software TSL OIM Data collection 5.31 and OIM Analysis 6.2). The average value obtained by performing measurement on a total of eight sites by setting the visual field range to x=500 μm and y=500 μm was used. Further, the step size was set to 1 μm.

TABLE 1

| | | Component composition (mass ratio) | | | | | | | | | | | | | [S + P + Se + | |
|---|---|---|---|---|---|---|---|---|---|---|---|---|---|---|---|---|
| | | | | Impurities | | | | | | | | | | | Te + Sb + | [Mg]/[S + P + |
| | | Mg | Ag | S | P | Se | Te | Sb | Bi | As | H | O | C | | Bi + As] | Se + Te + Sb + |
| | | ppm | ppm | ppm | ppm | ppm | ppm | ppm | ppm | ppm | ppm | ppm | ppm | Cu | ppm | Bi + As] |
| Examples | 1 | 12 | 4 | 3.1 | 2.1 | 1.5 | 1.9 | 1.1 | 0.6 | 1.2 | 0.3 | 1.4 | 0.2 | Balance | 11.5 | 1.0 |
| of | 2 | 16 | 10 | 3.4 | 2.9 | 1.5 | 1.2 | 0.6 | 1.6 | 1.9 | 0.8 | 2.1 | 0.3 | Balance | 13.1 | 1.2 |
| present | 3 | 22 | 12 | 3.6 | 9.8 | 2.9 | 2.7 | 3.4 | 2.6 | 2.9 | 0.6 | 1.3 | 0.2 | Balance | 27.9 | 0.8 |
| invention | 4 | 35 | 17 | 2.1 | 1.3 | 1.2 | 1.8 | 0.6 | 1.6 | 1.5 | 0.6 | 1.2 | 0.6 | Balance | 10.1 | 3.5 |
| | 5 | 40 | 12 | 3.4 | 0.3 | 0.4 | 0.2 | 0.3 | 0.3 | 0.6 | 0.2 | 1.0 | 0.1 | Balance | 5.5 | 7.3 |
| | 6 | 44 | 11 | 0.9 | 2.4 | 1.6 | 0.9 | 4.7 | 1.3 | 3.0 | 1.1 | 1.6 | 1.2 | Balance | 14.8 | 3.0 |
| | 7 | 49 | 6 | 0.7 | 2.3 | 1.1 | 0.4 | 0.9 | 0.8 | 0.6 | 0.9 | 0.9 | 1.3 | Balance | 6.8 | 7.2 |
| | 8 | 50 | 13 | 4.2 | 0.8 | 1.2 | 3.6 | 0.8 | 1.4 | 1.1 | 8.8 | 0.9 | 1.5 | Balance | 13.1 | 3.8 |
| | 9 | 53 | 0 | 1.2 | 1.6 | 1.2 | 0.5 | 0.4 | 1.5 | 0.9 | 0.4 | 1.1 | 0.6 | Balance | 7.3 | 7.3 |
| | 10 | 55 | 9 | 1.4 | 2.5 | 4.8 | 1.9 | 3.7 | 4.6 | 1.2 | 0.4 | 1.6 | 0.6 | Balance | 20.1 | 2.7 |
| | 11 | 58 | 9 | 5.6 | 1.7 | 1.8 | 0.9 | 0.5 | 0.3 | 0.8 | 0.6 | 1.8 | 4.4 | Balance | 11.6 | 5.0 |
| | 12 | 59 | 9 | 9.6 | 1.1 | 1.8 | 1.8 | 1.6 | 0.9 | 0.7 | 0.6 | 1.7 | 0.1 | Balance | 17.5 | 3.4 |
| | 13 | 60 | 12 | 0.9 | 0.9 | 3.1 | 1.2 | 1.4 | 0.4 | 0.6 | 0.5 | 1.3 | 0.3 | Balance | 8.5 | 7.1 |

TABLE 2

| | | Component composition (mass ratio) | | | | | | | | | | | | | [S + P + Se + | |
|---|---|---|---|---|---|---|---|---|---|---|---|---|---|---|---|---|
| | | | | Impurities | | | | | | | | | | | Te + Sb + | [Mg]/[S + P + |
| | | Mg | Ag | S | P | Se | Te | Sb | Bi | As | H | O | C | | Bi + As] | Se + Te + Sb + |
| | | ppm | ppm | ppm | ppm | ppm | ppm | ppm | ppm | ppm | ppm | ppm | ppm | Cu | ppm | Bi + As] |
| Examples | 14 | 61 | 11 | 3.4 | 3.6 | 1.6 | 4.8 | 1.1 | 1.0 | 4.2 | 1.8 | 0.8 | 0.3 | Balance | 19.7 | 3.1 |
| of | 15 | 63 | 11 | 7.6 | 4.5 | 0.8 | 1.1 | 1.1 | 1.3 | 1.6 | 3.9 | 0.1 | 0.2 | Balance | 18.0 | 3.5 |
| present | 16 | 66 | 12 | 8.2 | 1.8 | 0.9 | 1.6 | 1.2 | 3.2 | 1.9 | 1.1 | 1.3 | 9.1 | Balance | 18.8 | 3.5 |
| invention | 17 | 69 | 10 | 3.2 | 1.8 | 0.9 | 1.6 | 1.6 | 0.6 | 1.2 | 1.1 | 1.4 | 1.7 | Balance | 10.9 | 6.3 |
| | 18 | 70 | 13 | 3.5 | 0.2 | 0.4 | 0.1 | 0.3 | 0.4 | 0.5 | 0.3 | 1.1 | 0.1 | Balance | 5.4 | 13.0 |
| | 19 | 78 | 19 | 6.2 | 2.5 | 0.3 | 1.7 | 1.3 | 0.6 | 1.2 | 1.1 | 1.9 | 1.6 | Balance | 13.8 | 5.7 |
| | 20 | 81 | 9 | 4.5 | 1.6 | 1.6 | 1.9 | 1.0 | 1.3 | 1.3 | 0.9 | 12.0 | 1.2 | Balance | 13.2 | 6.1 |
| | 21 | 84 | 14 | 0.8 | 0.7 | 0.4 | 0.3 | 0.2 | 0.3 | 0.2 | 0.1 | 42.0 | 0.1 | Balance | 2.9 | 29.0 |
| | 22 | 99 | 12 | 0.6 | 0.6 | 0.1 | 0.2 | 0.2 | 0.2 | 0.2 | 0.1 | 62.0 | 0.5 | Balance | 2.1 | 47.1 |
| Comparative | 1 | 6 | 13 | 3.4 | 2.1 | 0.6 | 1.7 | 1.6 | 1.7 | 1.3 | 1.0 | 1.7 | 1.7 | Balance | 12.4 | 0.5 |
| examples | 2 | 2353 | 12 | 2.1 | 2.6 | 0.4 | 0.8 | 1.4 | 0.8 | 1.2 | 0.8 | 0.6 | 1.3 | Balance | 9.3 | 253.0 |
| | 3 | 51 | 11 | 7.4 | 8.4 | 4.5 | 4.7 | 4.6 | 4.8 | 4.5 | 0.9 | 1.8 | 1.6 | Balance | 38.9 | 1.3 |
| | 4 | 15 | 11 | 5.6 | 5.8 | 3.5 | 3.4 | 3.3 | 2.7 | 3.5 | 0.9 | 1.4 | 1.2 | Balance | 27.8 | 0.5 |
| | 5 | 55 | 12 | 3.7 | 2.1 | 0.3 | 0.4 | 1.3 | 1.3 | 1.1 | 1.2 | 1.4 | 0.4 | Balance | 10.2 | 5.4 |

TABLE 3

| | | Production step | | | | | | | | |
|---|---|---|---|---|---|---|---|---|---|---|
| | | Homogenizing | | | | | | | Finish working | |
| | | and solutionizing | | Hot working | | Heat treatment | | | Cross-sectional | Cross-sectional |
| | | Temperature | Time | Temperature | Extrusion | Temperature | Time | Cooling | area reduction | area |
| | | ° C. | sec. | ° C. | ratio | ° C. | h | method | ratio % | mm² |
| Examples | 1 | 900 | 3600 | 500 | 2 | 400 | 6 | Water | — | 1963 |
| of | | | | | | | | quenching | | |
| present | 2 | 1000 | 1800 | 450 | 5 | 550 | 10 | Water | 10 | 707 |
| invention | | | | | | | | quenching | | |
| | 3 | 800 | 1800 | 550 | 500 | 500 | 6 | Air cooling | 5 | 7 |
| | 4 | 700 | 3600 | 400 | 50 | 350 | 24 | Water | 5 | 64 |
| | | | | | | | | quenching | | |
| | 5 | 800 | 3600 | 500 | 20 | 600 | 1 | Air cooling | 15 | 133 |
| | 6 | 900 | 1800 | 550 | 5 | 450 | 18 | Water | 10 | 491 |
| | | | | | | | | quenching | | |
| | 7 | 800 | 1800 | 500 | 50 | 400 | 6 | Air cooling | 10 | 50 |
| | 8 | 700 | 1800 | 450 | 50 | 550 | 12 | Water | — | 79 |
| | | | | | | | | quenching | | |
| | 9 | 800 | 3600 | 600 | 60 | 500 | 6 | Air cooling | 10 | 50 |
| | 10 | 600 | 1800 | 550 | 10 | 600 | 1 | Water | 10 | 254 |
| | | | | | | | | quenching | | |
| | 11 | 1000 | 3600 | 450 | 10 | 500 | 10 | Air cooling | 10 | 113 |
| | 12 | 500 | 1800 | 600 | 2 | 700 | 1 | Water | 5 | 1385 |
| | | | | | | | | quenching | | |
| | 13 | 600 | 3600 | 550 | 10 | 350 | 6 | Air cooling | — | 254 |

TABLE 4

| | | Production step | | | | | | | | |
|---|---|---|---|---|---|---|---|---|---|---|
| | | Homogenizing | | | | | | | Finish working | |
| | | and solutionizing | | Hot working | | Heat treatment | | | Cross-sectional | Cross-sectional |
| | | Temperature | Time | Temperature | Extrusion | Temperature | Time | Cooling | area reduction | area |
| | | ° C. | sec. | ° C. | ratio | ° C. | h | method | ratio % | mm² |
| Examples | 14 | 700 | 1800 | 600 | 100 | 650 | 0.5 | Water | 10 | 20 |
| of | | | | | | | | quenching | | |
| present | 15 | 500 | 3600 | 500 | 20 | 450 | 6 | Air cooling | — | 133 |
| invention | 16 | 900 | 3600 | 550 | 5 | 550 | 10 | Water | 10 | 855 |
| | | | | | | | | quenching | | |
| | 17 | 500 | 1800 | 600 | 5 | 550 | 12 | Water | 10 | 573 |
| | | | | | | | | quenching | | |
| | 18 | 700 | 3600 | 500 | 20 | 600 | 1 | Air cooling | 15 | 133 |
| | 19 | 900 | 1800 | 400 | 20 | 500 | 10 | Water | — | 133 |
| | | | | | | | | quenching | | |
| | 20 | 800 | 3600 | 600 | 10 | 350 | 24 | Water | 5 | 254 |
| | | | | | | | | quenching | | |
| | 21 | 700 | 1800 | 500 | 100 | 500 | 10 | Air cooling | — | 38 |
| | 22 | 800 | 3600 | 450 | 2 | 400 | 18 | Air cooling | 10 | 804 |
| Comparative | 1 | 600 | 1800 | 500 | 50 | 600 | 1 | Air cooling | 10 | 79 |
| examples | 2 | 900 | 3600 | 550 | 5 | 450 | 12 | Air cooling | — | 962 |
| | 3 | 800 | 1800 | 450 | 60 | 500 | 24 | Water | 5 | 20 |
| | | | | | | | | quenching | | |
| | 4 | 1000 | 3600 | 550 | 10 | 450 | 6 | Water | — | 491 |
| | | | | | | | | quenching | | |
| | 5 | 700 | 1800 | 500 | 10 | 300 | 1 | Air cooling | 20 | 254 |

TABLE 5

| | | Texture | | | | Characteristics | | | |
|---|---|---|---|---|---|---|---|---|---|
| | | | Area ratio of | Area ratio of | | | | | Heat- |
| | | | crystals having | crystals having | Crystal grain | | | | resistant |
| | | | (100) plane | (123) plane | size of surface | Electrical | Tensile | Total | temperature |
| | | | orientation | orientation | layer region | conductivity | strength | elongation | after working |
| | | KAM | % | % | μm | % IACS | MPa | % | ° C. |
| Examples | 1 | 1.0 | 8 | 68 | 10 | 99.8 | 168 | 31 | 154 |
| of | 2 | 1.3 | 32 | 41 | 59 | 99.6 | 225 | 39 | 166 |
| present | 3 | 1.2 | 22 | 63 | 35 | 99.5 | 173 | 35 | 180 |
| invention | 4 | 0.8 | 5 | 67 | 4 | 99.1 | 186 | 31 | 201 |
| | 5 | 1.7 | 5 | 68 | 32 | 98.7 | 263 | 26 | 165 |
| | 6 | 1.1 | 15 | 61 | 22 | 98.8 | 232 | 34 | 403 |
| | 7 | 0.8 | 10 | 64 | 8 | 98.6 | 233 | 32 | 408 |
| | 8 | 1.3 | 35 | 45 | 58 | 98.5 | 203 | 39 | 410 |
| | 9 | 0.8 | 3 | 69 | 1 | 98.5 | 241 | 30 | 397 |
| | 10 | 1.4 | 51 | 47 | 72 | 98.5 | 242 | 39 | 409 |
| | 11 | 1.2 | 25 | 55 | 34 | 98.4 | 242 | 23 | 405 |
| | 12 | 1.7 | 78 | 69 | 119 | 98.4 | 215 | 28 | 407 |
| | 13 | 0.8 | 6 | 68 | 3 | 98.3 | 216 | 31 | 412 |

TABLE 6

| | | Texture | | | | Characteristics | | | |
|---|---|---|---|---|---|---|---|---|---|
| | | | Area ratio of | Area ratio of | | | | | Heat- |
| | | | crystals having | crystals having | Crystal grain | | | | resistant |
| | | | (100) plane | (123) plane | size in surface | Electrical | Tensile | Total | temperature |
| | | | orientation | orientation | layer region | conductivity | strength | elongation | after working |
| | | KAM | % | % | μm | % IACS | MPa | % | ° C. |
| Examples | 14 | 1.5 | 65 | 58 | 92 | 98.2 | 249 | 34 | 404 |
| of | 15 | 1.1 | 18 | 59 | 19 | 98.2 | 217 | 34 | 415 |
| present | 16 | 1.3 | 38 | 42 | 54 | 98.1 | 246 | 39 | 403 |
| invention | 17 | 1.3 | 39 | 39 | 55 | 97.9 | 247 | 39 | 405 |
| | 18 | 1.5 | 4 | 69 | 24 | 97.7 | 275 | 25 | 159 |
| | 19 | 1.2 | 22 | 53 | 33 | 97.8 | 227 | 35 | 416 |
| | 20 | 0.8 | 6 | 67 | 3 | 97.6 | 229 | 31 | 409 |
| | 21 | 1.2 | 21 | 53 | 32 | 97.5 | 234 | 35 | 418 |
| | 22 | 0.8 | 12 | 66 | 7 | 97.1 | 246 | 33 | 403 |
| Comparative | 1 | 1.4 | 52 | 48 | 70 | 99.9 | 199 | 39 | 138 |
| examples | 2 | 1.1 | 14 | 70 | 15 | 83.1 | 279 | 16 | 187 |
| | 3 | 0.8 | 3 | 67 | 1 | 98.6 | 205 | 30 | 141 |
| | 4 | 1.1 | 19 | 65 | 22 | 99.7 | 198 | 33 | 135 |
| | 5 | 1.9 | 1 | 85 | 2 | 98.4 | 298 | 15 | 139 |

In Comparative Example 1, since the amount of Mg was less than the range of the present invention, the heat resistance after working was insufficient.

In Comparative Example 2, since the amount of Mg was greater than the range of the present invention, the electrical conductivity was low.

In Comparative Example 3, since the total amount of S, P, Se, Te, Sb, Bi, and As was greater than 30 mass ppm, the heat resistance after working was insufficient.

In Comparative Example 4, since the mass ratio [Mg]/[S+P+Se+Te+Sb+Bi+As] was less than 0.6, the heat resistance after working was insufficient.

In Comparative Example 5, since the cross-sectional area reduction ratio in finish working was extremely high, the strength was greater than the range of the present invention, and thus the total elongation was low and the workability was poor. Further, the heat resistance after working was insufficient.

On the contrary, in Examples 1 to 22 of the present invention, the strength was low, the total elongation was high, and the workability was sufficiently excellent. Further, the electrical conductivity was increased. In addition, the heat resistance after working was also excellent.

As described above, according to the examples of the present invention, it was confirmed that a copper alloy plastically-worked material with high electrical conductivity, excellent workability, and excellent heat resistance even after application of working can be provided.

1. A copper alloy plastically-worked material comprising:
greater than 10 mass ppm and 100 mass ppm or less of Mg; and
a balance of Cu and inevitable impurities, wherein
the inevitable impurities comprise;
S in an amount of 10 mass ppm or less,
P in an amount of 10 mass ppm or less,
Se in an amount of 5 mass ppm or less,
Te in an amount of 5 mass ppm or less,
Sb in an amount of 5 mass ppm or less,
Bi in an amount of 5 mass ppm or less,
As in an amount of 5 mass ppm or less,
a total amount of S, P, Se, Te, Sb, Bi, and As is 30 mass ppm or less, and in a case where the amount of Mg is defined as [Mg] and the total amount of S, P, Se, Te, Sb, Bi, and As is defined as [S+P+Se+Te+Sb+Bi+As], a mass ratio of [Mg]/[S+P+Se+Te+Sb+Bi+As] is 0.6 or greater and 50 or less, an electrical conductivity is 97% IACS or greater, and a tensile strength is 275 MPa or less, and a heat-resistant temperature after application of draw working with a cross section reduction ratio of 25% is 150° C. or higher.

2. The copper alloy plastically-worked material according to claim 1,
wherein the tensile strength is 250 MPa or less.

3. The copper alloy plastically-worked material according to claim 1,
wherein a cross-sectional area of a cross section transverse to a longitudinal direction of the copper alloy plastically-worked material is 5 mm² or greater and 2,000 mm² or less.

4. The copper alloy plastically-worked material according to claim 1,
wherein a total elongation is 20% or greater.

5. The copper alloy plastically-worked material according to claim 1, further comprising:
Ag in a range of 5 mass ppm or greater and 20 mass ppm or less.

6. The copper alloy plastically-worked material according to claim 1,
wherein in the inevitable impurities further comprise;
H in an amount of 10 mass ppm or less,
O in an amount of 100 mass ppm or less, and
C in an amount of 10 mass ppm or less.

7. The copper alloy plastically-worked material according to claim 1,
wherein in a case where a measurement area of 10,000 μm² or greater in a cross section transverse to a longitudinal direction of the copper alloy plastically-worked material is ensured and defined as an observation surface of an EBSD method, a measurement point where a CI value at every measurement interval of 0.25 μm is 0.1 or less is removed, an orientation difference between crystal grains is analyzed, a boundary having 15° or greater of an orientation difference between neighboring measurement points is assigned as a crystal grain boundary, an average grain size A is acquired according to Area Fraction, measurement is performed at every measurement interval which is 1/10 or less of the average grain size A, a measurement area of 10,000 μm² or greater in a plurality of visual fields is ensured such that a total of 1,000 or more crystal grains are included, and defined as an observation surface, a measurement point where a CI value analyzed by data analysis software OIM is 0.1 or less is removed, an orientation difference between crystal grains is analyzed, and a boundary having 5° or greater of an orientation difference between neighboring pixels is assigned as a crystal grain boundary, an average value of Kernel Average Misorientation (KAM) values is 1.8 or less.

8. The copper alloy plastically-worked material according to claim 1,
wherein in a cross section transverse to a longitudinal direction of the copper alloy plastically-worked material, an area ratio of crystals having (100) plane orientation is 3% or greater, and an area ratio of crystals having (123) plane orientation is 70% or less.

9. The copper alloy plastically-worked material according to claim 1,
wherein in a cross section transverse to a longitudinal direction of the copper alloy plastically-worked material, an average crystal grain size of a surface layer region of greater than 200 μm to 1,000 μm from an outer surface toward a center is in a range of 1 μm or greater and 120 μm or less.

10. A copper alloy rod material comprising:
the copper alloy plastically-worked material according to claim 1,
wherein a diameter of a cross section transverse to a longitudinal direction of the copper alloy plastically-worked material is in a range of 3 mm or greater and 50 mm or less.

11. A component for electronic/electrical devices, comprising:
the copper alloy plastically-worked material according to claim 1.

12. A terminal comprising:
the copper alloy plastically-worked material according to claim 1.
